(19) United States
(12) Patent Application Publication
(10) Pub. No.: US 2010/0030700 A1
(43) Pub. Date: Feb. 4, 2010

(54) Method for analyzing an investment using net present value and internal rate of return

(76) Inventor: Jerry Donald Mays, Stockbridge, GA (US)

Correspondence Address: Jerry Donald Mays, 950 Eagles Landing Pkwy #256, Stockbridge, GA, 30281, US

(21) Appl. No.: 12/220,886

(22) Filed: Jul. 29, 2008

(51) Int. Cl. G06Q 40/00; G06F 17/11

(52) U.S. Cl. 705/36 R

(57) ABSTRACT

A new method for calculating the net present value and internal rate of return on an investment is provided. Here, the new method takes into account discounts that affect the net cash flow over the period of the investment. These discounts may be static or vary depending on the circumstances warranting their inclusion.

### BACKGROUND OF THE INVENTION

1. Field of the Invention

This invention relates to a method for determining the net present value or internal rate of return of an investment opportunity.

2. Description of Related Art

An object of financial transactions is to efficiently relate the valuation and risk of an investment created in the course of an enterprise to monetary sums which may be paid for or advanced against such an investment. A primary purpose for such transactions is the increase in capital which may be invested in other items. Two requirements of financial transactions are: (a) a means by which providers of capital may reasonably determine whether to enter into particular financial transactions with investors, and (b) a means for affecting the exchange of capital and property, respectively.

Net present value (NPV) is a standard method for the financial appraisal of long-term projects. Used for capital budgeting, and widely throughout economics, it measures the excess or shortfall of cash flows, in present value (PV) terms, once financing charges are met. By definition, NPV equals the present value of net cash flows. In calculating the NPV, each cash inflow/outflow is discounted back to its present value (PV). Then they are summed. Therefore:

$$NPV = {I}_{0} + \frac{{I}_{1}}{1 + r} + \frac{{I}_{2}}{{( 1 + r )}^{2}} + \frac{{I}_{3}}{{( 1 + r )}^{3}} + … + \frac{{I}_{n}}{{( 1 + r )}^{n}}$$

Where
n—the time of the cash flow
r—the rate of return (the rate of return that could be earned on an investment in the financial markets with similar risk)
Iₙ—the net cash flow (the amount of cash) at time (n)
I₀ is the initial investment (Present Value)

The rate of return used to discount future cash flows to their present values is a key variable of this process. A weighted average rate of return (after tax) is often used, but many people believe that it is appropriate to use higher rates to adjust for risk for riskier projects. A variable rate with higher rates applied to cash flows occurring further along the time span might be used to reflect the yield curve premium for long-term debt.

Another approach to choosing the rate of return factor is to decide the rate which the capital needed for the project could return if invested in an alternative venture. If, for example, the capital required for Project A can earn five percent elsewhere, the second rate of return may be used in the NPV calculation to allow a direct comparison to be made between Project A and the alternative.

NPV is an indicator of how much value an investment or project adds to the value of the user. With a particular project, if Iₙ is a positive value, the project is in the status of discounted cash inflow in the time of t. If Iₙ is a negative value, the project is in the status of discounted cash outflow in the time of n. Appropriately risked projects with a positive NPV could be accepted. This does not necessarily mean that they should be undertaken since NPV at the cost of capital may not account for opportunity cost, i.e. comparison with other available investments. In financial theory, if there is a choice between two mutually exclusive alternatives, the one yielding the higher NPV should be selected.

The Internal Rate of Return (IRR) is a capital budgeting metric used by investors to decide whether they should make particular investments. It is an indicator of the efficiency of an investment, as opposed to NPV, which indicates value or magnitude. The IRR is the annualized effective compounded rate which can be earned on the invested capital, i.e., the yield on the investment.

A project is a good investment if its IRR is greater than the rate of return that could be earned by alternative investments. Thus, the IRR should be compared to any alternative costs of capital including an appropriate risk premium.

Mathematically, the IRR is defined as any rate of return (r) that results in a NPV equal to zero in a series of cash flows. In general, if the IRR is greater than the project's cost of capital, the project will add value to the company.

Various computational means exist that constitute prior art for measuring the reasonable market value of financial transactions involving properties owned by an investor. In the case of tangible properties and real estate, a principal element of the means has been the existence of a marketplace wherein the payment or advancement of cash sums for similar properties occurs regularly and information is consequently available to participants in other such transactions. This permits a comparison of material terms and conditions for a specific financial transaction based on its similarity or, alternatively, its dissimilarity to prior financial transactions which occurred in a specific marketplace.

However, the use of the conventional methods for calculating the NPV (as discussed below) for an investment do not take into consideration how projected inflowing or outflowing cash amounts may vary, depending upon considerations of percentage discounts due to outside parameters, thus affecting the NPV or IRR of a transaction. This shortcoming is readily apparent when, for example, analyzing a real estate transaction where monthly or yearly interest rates can vary on an investment. In that instance, the conventional methods do not provide an accurate calculation of the real NPV of an investment.

Accordingly, there is a need for a method that allows an investor to vary discounts for consideration of increases and decreases in net cash flow (Iₙ) when calculating the NPV or IRR of an investment. More specifically, there is a need for a method that allows the investor to supplement or discount the net cash flow where the net cash flow may be affected over the period of an investment. Additionally, in instances where the net cash flow may be affected on a year to year basis, there is a need to represent those instances to provide an accurate valuation of an investment.

### SUMMARY OF INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

An object of the present invention is to provide a means whereby an investor may vary amounts for increases and decreases in net cash flow (Iₙ) when calculating the NPV or IRR of an investment. A further object of the invention is to provide a means that allows the investor to supplement or discount the net cash flow where the net cash flow may be affected over the period of an investment. In this method, the investment can have the tax treatment of a sale included in the NPV or IRR to account for predictable future payments and permits ready valuation of the current value of the security at any time during the life of the agreement.

A further object of the present invention is to provide a more accurate means to relate the valuations and risks associated with different investments to each other and to other financial transactions.

A still further object of the present invention is to provide a means by which the net cash flow may be accounted for on a year to year basis when needed. The aforementioned means shall also provide for the allocation of and accounting for equitable interests, income, and liabilities by and among the respective parties. Collectively, the means contemplated by the present invention are embodied in certain novel software, flowcharts and computational algorithms which separately and collectively constitute the devices and utilities to accomplish the aforementioned objects of the present invention.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 is an exemplary illustration of a net present value and internal rate of return calculation in accordance with conventional methods of calculating NPV.

FIG. 2 is an exemplary illustration of a novel net present value and internal rate of return calculation, wherein the incoming cash flow is discounted by a rate over the period of the investment, in accordance with this invention.

FIG. 3 is an exemplary illustration of a second novel net present value and internal rate of return calculation, wherein the incoming cash flow is discounted by variable rates over the period of the investment, in accordance with this invention.

FIG. 4 represents a block diagram depicting one exemplary embodiment of a net present value and internal rate of return system according to this invention.

FIG. 5 represents a block diagram depicting one exemplary embodiment of a net present value and internal rate of return program according to this invention.

FIG. 6 represents and exemplary method for the net present value and internal rate of return system according to this invention.

### DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced without these specific details.

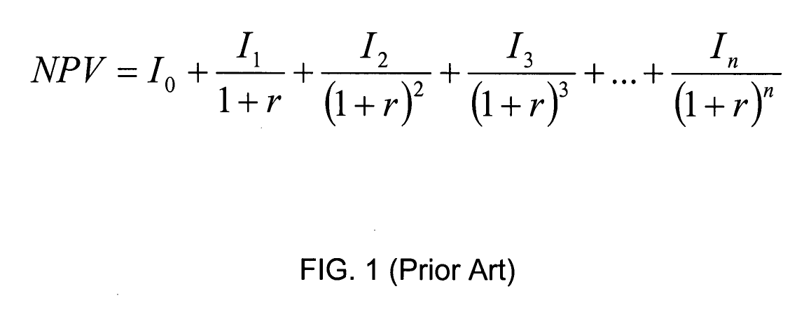

The illustration shown in FIG. 1 represents the conventional method for calculating the NPV of an investment. Here, the investor will input into the equation the values related to n (the length of the investment), r (the rate of return), and Iₙ (the net cash flow received from the initial investment, I₀). These values may relate to property available for valuation or any other expenditure made for an investment. Such as, for example, the cost of a piece of equipment (I₀) and the amount of cash flow expected from the initial investment.

### Specific Example Using Conventional Method (NPV)

The following information is known about the investment: The heavy machinery costs $30,000 (I₀); the projected monthly revenue minus the costs for operation of the machinery (net cash flow (Iₙ)) is $6000; and the expected rate of return (r) on the investment is 5 percent. The analysis of the investment is shown in Table 1 below.

TABLE 1

| | Net Cash Flow | | | | | | | |
|---|---|---|---|---|---|---|---|---|
| | I₀ | I₁ | I₂ | I₃ | I₄ | I₅ | I₆ | NPV |
| Income | −30000 | 6000 | 6000 | 6000 | 6000 | 6000 | 6000 | 454.17 |
| Present | | 5714.29 | 5442.18 | 5183.03 | 4936.22 | 4701.16 | 4477.29 | |
| Value (r = 5%) | | | | | | | | |
| Progress | | −24285.71 | −18843.53 | −13660.50 | −8724.28 | −4023.12 | 454.17 | |

As seen in Table 1, the investment becomes profitable as compared to the initial investment (I₀) during year 6. However, this method does not allow the investor to discount the net cash flow (Iₙ) based on circumstances that may affect its amounts. Such as, for example, if the investment income needs to be discounted or supplemented due to a deferred loan period ending or in the alternative where a loan amount has been paid off for the machinery.

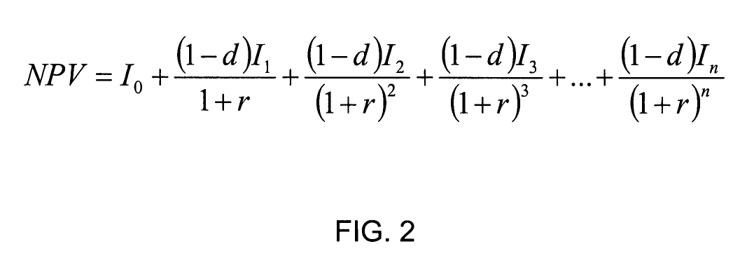

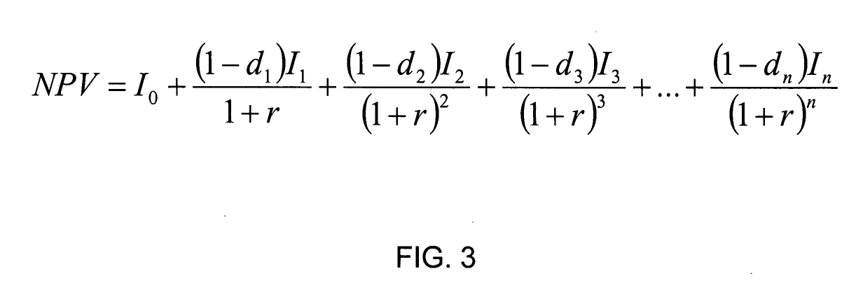

The illustrations shown in FIGS. 2 and 3 represent exemplary embodiments of the new methods, according to this invention, for calculating the NPV or IRR of an investment. Here again, the investor will input into the equations shown in FIGS. 2 and 3 values related to n (the length of the investment), r (the rate of return), Iₙ (the net cash flow received from the initial investment), and the initial investment amount, I₀. For comparison purposes, the same values as related to FIG. 1 will be used. However, in the equation as shown in FIG. 2 and where the evaluation is shown in Table 2 below, for example, the investor may add a constant discount over the life of the loan for situations as described above. These values may relate to any discount that would affect the net income or any other expenditure made for an investment.

### Specific Example Using New Methods (NPV)

Using the initial parameters as discussed above with respect to FIG. 1, and a discount percentage (d=10%) according to the novel aspects of this invention, the resulting figures represent the real valuation that this associated with this invention. In this example, the discount has been applied to the net cash flow, making the net cash flow in this case $5400 each year.

TABLE 2

| | Net Cash Flow | | | | | | | |
|---|---|---|---|---|---|---|---|---|
| | I₀ | I₁ | I₂ | I₃ | I₄ | I₅ | I₆ | NPV |
| Income | −30000 | 5400 | 5400 | 5400 | 5400 | 5400 | 5400 | −2591.26 |
| Present | | 5142.86 | 4897.96 | 4664.72 | 4442.59 | 4231.04 | 4029.56 | |
| Value (r = 5%) | | | | | | | | |
| Progress | | −24857.14 | −19959.18 | −15294.46 | −10851.86 | −6620.83 | −2591.26 | |

As seen in Table 2, the investment becomes profitable as compared to the initial investment (I₀) some time after year 6. Here the investor has the ability to discount the cash flow for the six year period to accurately account for the circumstances that could arise. Such as, for example, for the first six years, there may have been installment payments that were made on the investment until it was fully acquired for ownership.

In the exemplary embodiment as shown in FIG. 3, the investor may add a varying discount over the life of the investment for situations where the discount applied to the net cash flow is not constant. These values may relate to any discount that would affect the net income or any other expenditure made for an investment.

Again using the initial parameters as discussed above with respect to FIG. 1, and varying discount percentages (dₙ) according to the novel aspects of this invention, the resulting figures represent the real valuation that this associated with this invention. In this example, discounts of 10%, 20%, 30%, 15%, 13%, and 10%, respectively have been applied to the net cash flow ($6000), making the net cash flow vary each according to the novel aspects as shown in FIG. 3 and Table 3 below.

TABLE 3

| | Net Cash Flow | | | | | | | |
|---|---|---|---|---|---|---|---|---|
| | I₀ | I₁ | I₂ | I₃ | I₄ | I₅ | I₆ | NPV |
| Income | −30000 | 5400 | 4800 | 4200 | 5100 | 5220 | 5400 | −4559.93 |
| Present | | 5142.86 | 4353.47 | 3628.12 | 4195.78 | 4090.01 | 4029.56 | |
| Value (r = 5%) | | | | | | | | |
| Progress | | −24857.14 | −20503.40 | −16875.28 | −12679.50 | −8589.49 | −4559.93 | |

As seen in Table 3, the investment becomes profitable as compared to the initial investment (I₀) some time well after year 6. Again, as in FIG. 2, the investor has the ability to discount the cash flow for the six year period to accurately account for the circumstances where the discount will vary each year. Such as, for example, for the first six years, there may be fluctuations in fuel costs over the period of years, in the case of the heavy machinery example shown above.

It should be easily recognized that the IRR for the investment may be calculated by simply setting NPV to zero and calculating for r. By substituting zero into the equation as the value of NPV, the illustration shown in FIG. 1 represents the conventional method for calculating the IRR of an investment. Here, the investor will input into the equation the values related to n (the length of the investment), r (the rate of return), and Iₙ (the net cash flow received from the initial investment, I₀). These values may relate to property available for valuation or any other expenditure made for an investment. Such as, for example, the cost of a piece of equipment (I₀) and the amount of cash flow expected from the initial investment.

### Specific Example Using Conventional Method (IRR)

Similar to the illustration shown in Table 1 above, the following information is known about the investment: The heavy machinery costs $30,000 (I₀); the projected monthly revenue minus the costs for operation of the machinery (net cash flow (Iₙ)) is $20000. Here however, we can calculate the IRR (r) of the investment. This analysis is shown in Table 4 below.

TABLE 4

| | Net Cash Flow | | | | | | | |
|---|---|---|---|---|---|---|---|---|
| | I₀ | I₁ | I₂ | I₃ | I₄ | I₅ | I₆ | |
| Income | −30000 | 20000 | 20000 | 20000 | 20000 | 20000 | 20000 | |
| IRR (r) | | −33.3% | 21.53% | 44.63% | 55.17% | 60.38% | 63.13% | IRR |

As seen in Table 4, the investment becomes profitable as compared to the initial investment (I₀) during year 2. However, this method does not allow the investor to discount the net cash flow (Iₙ) based on circumstances that may affect its amounts. Such as, for example, if the investment income needs to be discounted or supplemented due to a deferred loan period ending or in the alternative where a loan amount has been paid off for the machinery.

As mentioned above, the illustrations shown in FIGS. 2 and 3 represent exemplary embodiments of the new methods, according to this invention, for calculating the NPV or IRR of an investment. Here again, the investor will input into the equations shown in FIGS. 2 and 3 values related to n (the length of the investment), Iₙ (the net cash flow received from the initial investment), and the initial investment amount, I₀. For comparison purposes, the same values as related to Table 4 will be used. However, in the equation as shown in FIG. 2 and where the evaluation is shown in Table 5 below, for example, the investor may add a constant discount over the life of the loan for situations as described above. These values may relate to any discount that would affect the net income or any other expenditure made for an investment.

### Specific Example Using New Methods (IRR)

Using the initial parameters as discussed above with respect to Table 4, and a discount percentage (d=10%) according to the novel aspects of this invention, the resulting figures represent the real valuation and internal rate of return associated with this invention. In this example, the discount has been applied to the net cash flow, making the net cash flow in this case $18000 each year.

TABLE 5

| | Net Cash Flow | | | | | | |
|---|---|---|---|---|---|---|---|
| | I₀ | I₁ | I₂ | I₃ | I₄ | I₅ | I₆ |
| In- | −30000 | 18000 | 18000 | 18000 | 18000 | 18000 | 18000 |
| come | | | | | | | |
| IRR | | −40.0% | 13.07% | 36.31% | 47.23% | 52.80% | 55.81% |
| (r) | | | | | | | |

As seen in Table 5, the investment becomes profitable as compared to the initial investment (I₀) some time after year 2. Here the investor has the ability to discount the cash flow for the six year period to accurately account for the circumstances that could arise. Such as, for example, for the first six years, there may have been installment payments that were made on the investment until it was fully acquired for ownership.

In the exemplary embodiment as shown in Table 6, the investor may add a varying discount over the life of the investment for situations where the discount applied to the net cash flow is not constant. These values may relate to any discount that would affect the net income or any other expenditure made for an investment.

Again using the initial parameters as discussed above with respect to Table 4, and varying discount percentages (dₙ) according to the novel aspects of this invention, the resulting figures represent the real valuation that this associated with this invention. In this example, discounts of 10%, 20%, 30%, 15%, 13%, and 10%, respectively have been applied to the net cash flow ($6000), making the net cash flow vary each according to the novel aspects as shown in FIG. 3 and Table 6 below.

TABLE 6

| | Net Cash Flow | | | | | | |
|---|---|---|---|---|---|---|---|
| | I₀ | I₁ | I₂ | I₃ | I₄ | I₅ | I₆ |
| Income | −30000 | 18000 | 16000 | 14000 | 17000 | 17400 | 18000 |
| IRR (r) | | −40.00% | 8.95% | 29.22% | 41.25% | 47.51% | 51.02% |

As seen in Table 6, the investment becomes profitable as compared to the initial investment (I₀) some time well after year 2. Again, as in Table 5, the investor has the ability to discount the cash flow for the six year period to accurately account for the circumstances where the discount will vary each year. Such as, for example, for the first six years, there may be fluctuations in fuel costs over the period of years, in the case of the heavy machinery example shown above.

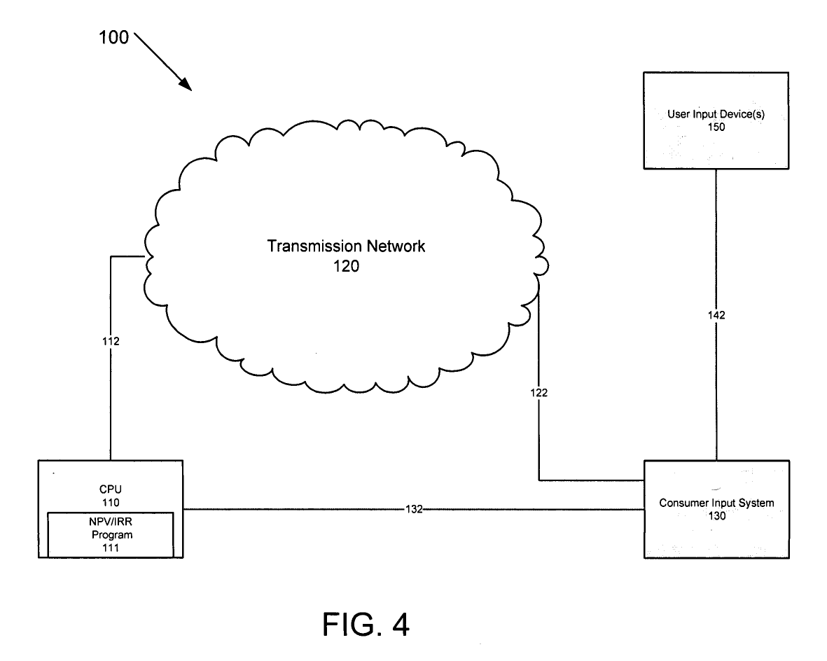

FIG. 4 shows one exemplary embodiment of a net present value and internal rate of return (NPV/IRR) system 100, according to this invention, that includes a consumer input system 130. As shown in FIG. 4, one or more user input devices 150 are connected to the consumer input system 130 via one or more communication links 142. The one or more user input devices 150 can be any known or later-developed device usable to input data and/or commands, such as a keyboard, a mouse, a voice recognition system, a digital ink pen, a trackball, a track pad or the like. The consumer input system 130 is connected to a CPU 110 of the net present value and internal rate of return system 100 either directly over a link 132 or over links 122 and 112 and a transmission network 120 of the net present value and internal rate of return system 100.

The bidirectional links 112, 122, 132 and 142 and the transmission network 120 can be any now known or later-developed device or system usable to connect the one or more user input devices 150 and the CPU 110 to the consumer input system 130, including, but not limited to, a direct cable connection, a connection over a wide area network or a local network, a connection over an intranet or a connection over an extranet, a connection over the Internet, a wireless connection, or a connection over any other distributed processing network or system. In general, the links 112, 122, 132 and 142 and the transmission network 120 can be any appropriate known or later-developed connection system and/or structure for transferring information, such as computer readable program code, a carrier wave and/or any other type of executable program or instruction.

The CPU 110 contains a net present value and internal rate of return (NPV/IRR) program 111. NPV/IRR data, such as text, can be retrieved by the consumer input system 130 from the NPV/IRR program 111 through CPU 110 and collaboratively shared by the components of the consumer input system 130. It should be appreciated that CPU 110 can be a local or remotely located computer, or any other known or later-developed system usable to generate electronic data or beverage classification information. Similarly, the CPU 110 can be any suitable device that stores and/or transmits electronic NPV/IRR data, such as a client or a server of a network. The CPU 110 can be integrated with the consumer input system 130 or may be remotely connected to the consumer input system 130, such as over the transmission network 120.

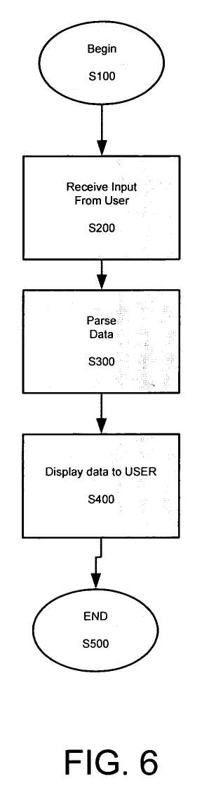

It should also be appreciated that the NPV/IRR program 111 is preferably dynamically implemented on a general-purpose computer, for example CPU 110. However, the NPV/IRR program 111 can also be implemented on a special purpose computer, a programmed microprocessor or microcontroller and peripheral integrated circuit elements, an ASIC or other integrated circuit, digital signal processor, hardwired electronic or logic circuit such as discrete element circuit, programmable logic device such as PLD, PLA, FPGA or PAL, or the like. In general, any device capable of supplying appropriate NPV/IRR data that can be used in the flowcharts shown in FIG. 6 can be used.

Alternatively, the NPV/IRR system 100 may include firmware and/or other updates accessible across the link 112 that will either access software or a webpage wirelessly for instructions, updates and/or upgrades. The user may access this same information through a connection made through a landline network connection. However, it will be apparent that any method of transferring the data information may be used in the practice of this invention.

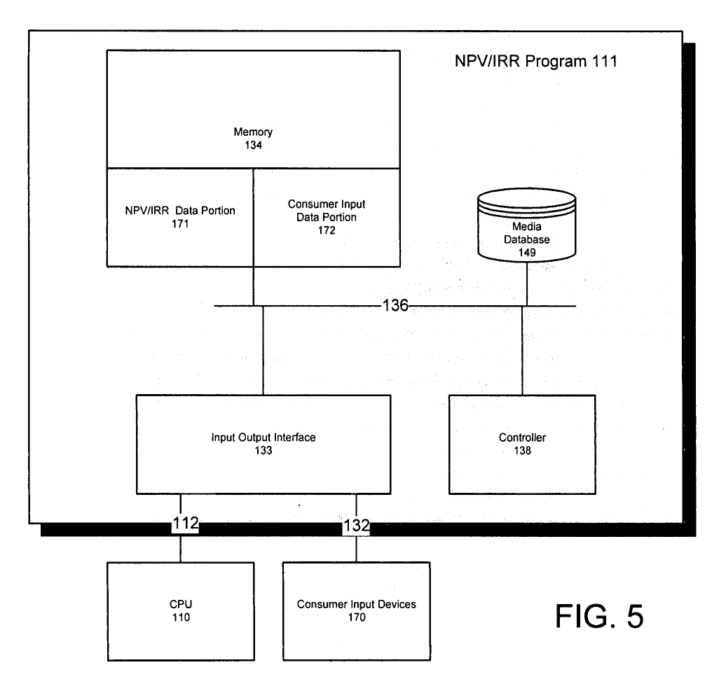

FIG. 5 illustrates one exemplary embodiment of various components of the NPV/IRR program 111 according to this invention. As shown, the NPV/IRR program 111 includes an input/output interface 133, controller 138, memory 134, and a media database 149, each interconnected by one or more bidirectional data/control buses or application programming interfaces 136. As further shown in FIG. 5, one or more consumer input devices 170 are connected over one or more links 132 to the input/output interface 133. The consumer input device 170 includes the user input device 150 and the consumer input system 130 from FIG. 4. Additionally, CPU 110 is connected over communication link 112 to the input/output interface 133.

It should be understood that each of the circuits or routines shown in FIGS. 4 and 5 could be implemented as portions of suitably programmed general-purpose computer. Alternatively, each of the circuits or routines in FIGS. 4 and 5 could be implemented as physically distinct hardware circuits within an ASIC or using FPGA, PDL, PLA or PAL, digital signal processor, or using discrete logic elements or discrete circuit elements. The particular form of each of the circuits or routines shown in FIGS. 4 and 5 will take is design choice and will be obvious and predicable to those skilled in the art.

Each of the links 112 and 132 can be implemented using any known or later developed device or system for connecting the one or more consumer input devices 170 and CPU 110, respectively to the NPV/IRR program 111, including direct cable connection, connection over wide area network, local network or storage area network, connection over an intranet, connection over the Internet, or connection over any other distributed processing network or system. In general, each of the links 112 and 132 can be any known or later developed connection system or structure usable to connect the one or more consumer input devices 170 and CPU 110 to the NPV/IRR program 111.

The input/output interface 133 inputs consumer input data from the CPU 110 and/or the one or more consumer input devices 170 and outputs data to a display a known in the art. The input/output interface 133 also outputs the NPV/IRR data to one or more of the controller(s) 138, the memory 134, and the media database 134.

The memory 134 includes one or more of a NPV/IRR data portion 171 and a consumer input portion 172. The NPV/IRR data portion 171 stores the NPV/IRR data into which the consumer input portion 172 will be embedded to form results information, as later discussed herein. The memory 134 can also store one or more computer readable control routines used by the controller 138 to operate the NPV/IRR program 111. The NPV/IRR data portion 171 also includes the methods and formulas for calculating NPV/IRR as discussed above with respect to FIGS. 2 and 3.

The memory 134 can be implemented using any appropriate combination of alterable, volatile or non-volatile memory or non-alterable, or fixed, memory. The alterable memory, whether volatile or non-volatile, can be implemented using any one or more of static or dynamic RAM, floppy disk and disk drive, writable or re-writable optical disk and disk drive, hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

The controller 138 can be implemented as single special purpose integrated circuit (e.g., ASIC) each having main or central processor section for overall, system-level control, and separate sections dedicated to performing various different specific computations, functions and other processes under the control of the central processor section. The controller 138 can also be implemented as single microprocessor circuit or plurality of separate dedicated or programmable integrated or other electronic circuits or devices, e.g., hardwired electronic or logic circuits such as discrete element circuits or programmable logic devices. The controller 138 also preferably includes other circuitry or components, such as memory devices, relays, mechanical linkages, communications devices, etc., to affect desired control and/or input/output functions.

The media database 149 can be implemented using any hardware or software means capable of producing collections of data structured and organized in disciplined fashion so that access to the information of interest is possible. The database structure can be stored in any now known or later developed way of structure, such as comma delineated.

The media database 149 can contain preprogrammed sets of investment data, rate of return, net present values of other investments and other relevant information for use by the NPV/IRR data portion 171 to be used by the user as discussed above with respect to FIGS. 2 and 3. For example, the media database may contain national interest rates, other investment analyses, cost structures of materials and goods to be used in an investment and any other relevant information.

In operation, and upon initiation of the NPV/IRR program 111 contained on or connected to CPU 110, the NPV/IRR data portion 171, through the input/output interface 133 and over the link 112, retrieves the consumer input data portion 172 from the NPV/IRR program 111 that represents the consumer input data from consumer input device 170. This process begins the initialization process of the NPV/IRR program 111. The initialization process performs the association and storage of the NPV/IRR data portion 171 with the information input by a consumer, shown herein as consumer input data portion 172.

The controller 138 then translates the incoming consumer input data portion 172 into a desired format to create an association between the consumer input data portion 172 and the NPV/IRR data portion 171. The desired formats include storing the consumer input data portion as NPV/IRR data and using linking information from the media database 149 to the NPV/IRR data portion 171. The translation process can be implemented using any system capable of creating, inter alia, cost structures, generating interest rate information and making queries into retail stores and suppliers to determine costs of materials, labor, etc.

Upon completion of the translation process, the input/output interface 133, under the control of the controller 138, associates the cost structures, interest rate information and retail stores, etc to the net cash flow as described above. The associated information is then stored in the NPV/IRR data portion 171 of the memory 134. The NPV/IRR data portion 171 including the associated hyperlink, pointer, etc. is displayed to the user on a display using conventional methods.

Once the initialization process of the NPV/IRR program 111 is completed, the system of this invention enters a normal operation mode. During the normal operation, when the NPV/IRR program 111 receives input information from the consumer input device 170, the NPV/IRR program 111 searches the media database 149 to identify retail store and company cost structures, generate interest rate information and makes queries into retail stores and suppliers to determine costs of materials, labor. These values are then input into the equations as described above with respect to FIGS. 2 and 3. Once the appropriate calculations are competed, the desired information is displayed to the user.

Although the above steps have been described with use of information from the media database 149, it should be appreciated that the user may input any appropriate information needed without the intervention of the media database 149 during the normal operation mode.

FIG. 6 represents an exemplary method for the net present value and internal rate of return system according to this invention. As shown in FIG. 6, operation of the method begins at step S100, and continues to step S200, where the net present value and internal rate of return system receives input from a user indicating the required parameters to be input into the novel equations according to this invention.

Then in step S300, the net present value and internal rate of return system will then parse using a controller to decipher the information input by the consumer and retrieve NPV/IRR data based on the information input by the user and the equations shown in FIGS. 2 and 3. The process continues to step S400.

At step S400, where the NPV/IRR system, based on the input information will out put the desired information for display to the user.

The process then ends at step S500.

While the present invention has been described with respect to purchasing a tangible object, such as machinery, this invention is applicable over a broad range of applications wherein initial investment capital is presented and an expected net cash flow is expected over a period of time. As set forth in the detailed description of the embodiments, including the evaluation results therein, the present invention has achieved results far exceeding those which would be reasonably expected by those skilled in the art.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for evaluation of an investment, comprising:
receiving at least the following input information from an outside source:
n—the time of the cash flow;
r—the rate of return;
Iₙ—the net cash flow;
I₀—the initial investment; and
d—the rate at which the net cash flow will discounted,

2. The method of claim 1, wherein the input information is used to calculate the net present value using the following equation:
$$NPV = {I}_{0} + \frac{( 1 - d ) {I}_{1}}{1 + r} + \frac{( 1 - d ) {I}_{2}}{{( 1 + r )}^{2}} + \frac{( 1 - d ) {I}_{3}}{{( 1 + r )}^{3}} + … + \frac{( 1 - d ) {I}_{n}}{{( 1 + r )}^{n}}$$

3. The method of claim 1, wherein the input information is used to calculate the internal rate of return using the following equation:
$$0 = {I}_{0} + \frac{( 1 - d ) {I}_{1}}{1 + r} + \frac{( 1 - d ) {I}_{2}}{{( 1 + r )}^{2}} + \frac{( 1 - d ) {I}_{3}}{{( 1 + r )}^{3}} + … + \frac{( 1 - d ) {I}_{n}}{{( 1 + r )}^{n}}$$

4. A method for evaluation of an investment, comprising:
receiving at least the following input information from an outside source:
n—the time of the cash flow;
r—the rate of return;
Iₙ—the net cash flow;
I₀—the initial investment; and
dₙ—the rates at which the net cash flow will discounted in each year n

5. The method of claim 4, wherein the input information is used to calculate the net present value using the following equation:
$$NPV = {I}_{0} + \frac{( 1 - {d}_{1} ) {I}_{1}}{1 + r} + \frac{( 1 - {d}_{2} ) {I}_{2}}{{( 1 + r )}^{2}} + \frac{{( 1 - d )}_{3} {I}_{3}}{{( 1 + r )}^{3}} + … + \frac{( 1 - {d}_{n} ) {I}_{n}}{{( 1 + r )}^{n}}$$

6. The method of claim 4, wherein the input information is used to calculate the internal rate of return using the following equation:
$$0 = {I}_{0} + \frac{( 1 - {d}_{1} ) {I}_{1}}{1 + r} + \frac{( 1 - {d}_{2} ) {I}_{2}}{{( 1 + r )}^{2}} + \frac{( 1 - {d}_{3} ) {I}_{3}}{{( 1 + r )}^{3}} + … + \frac{( 1 - {d}_{n} ) {I}_{n}}{{( 1 + r )}^{n}}$$
